(19) United States
(12) Patent Application Publication
(10) Pub. No.: US 2013/0211907 A1
(43) Pub. Date: Aug. 15, 2013

(54) CLASSIFIED ADVERTISING IN A SOCIAL NETWORKING SYSTEM

(71) Applicants: Jared S. Morgenstern, Menlo Park, CA (US); Joshua R. Pritchard, Palo Alto, CA (US)

(72) Inventors: Jared S. Morgenstern, Menlo Park, CA (US); Joshua R. Pritchard, Palo Alto, CA (US)

(21) Appl. No.: 13/827,637

(22) Filed: Mar. 14, 2013

Related U.S. Application Data
(63) Continuation of application No. 12/151,734, filed on May 7, 2008.
(60) Provisional application No. 60/928,313, filed on May 8, 2007.

(51) Int. Cl. G06Q 30/02

(52) U.S. Cl. CPC G06Q 30/0245
USPC 705/14.44

(57) ABSTRACT

Exemplary systems and methods are provided for advertising on an authenticated web-based social network. Such methods include providing a screen for creation of a classified advertisement, receiving the classified advertisement from an advertising member, and displaying the classified advertisement on a user network in the authenticated web-based social network with information about a relationship between the advertising member and a member of the authenticated web-based social network viewing the classified advertisement. Exemplary systems include an advertising engine configured to generate a screen for creation of a classified advertisement, a communications module configured to receive the classified advertisement from, an advertising member, a distributed database configured with a user network and relationship information, and a display module configured to display the classified advertisement on the user network with the relationship information.

### CROSS-REFERENCE TO RELATED APPLICATIONS

The present application claims the benefit and priority of U.S. Provisional Patent Application Ser. No. 60/928,313 filed on May 8, 2007, titled “Systems and Methods for Classified Advertising in an Authenticated Web-Based Social Network,” which is hereby incorporated by reference.

The present application incorporates herein by reference the following applications: U.S. patent application Ser. No. 11/701,744 filed on Feb. 2, 2007, titled, “System and Method for Curtailing Objectionable Behavior in a Web-Based Social Network,” U.S. patent application Ser. No. 11/701,595 filed on Feb. 20, 2007, titled “System and Method for Determining a Trust Level in a Social Network,” and U.S. patent application Ser. No. 11/726,962 filed on Mar. 23, 2007, titled “System and Method for Confirming an Association in a Web-Based Social Network.”

### BACKGROUND OF THE INVENTION

1. Field of the Invention

The present invention relates generally to advertising, and more particularly to systems and methods for advertising in an authenticated web-based social network.

2. Description of Related Art

Conventional Internet advertising suffers from several drawbacks. First, advertisers are typically unverified as to their identity, reputation and/or association. Even if an advertiser is purportedly verified, the verification or the integrity of the verification process may be questionable. Second, an advertiser, the advertised product, or the advertised service may be geographically distant from an Internet user seeking to inspect and/or purchase the product and/or service. Third, information about an advertised product or service may be lacking from an advertisement, which often requires a potential purchaser using the Internet to spend time sending inquiries to an advertiser, and waiting for responses from the advertiser. Fourth, there is no way of sharing information with friends of a particular Internet user about a recent purchase or sale of a particular good or service. Thus, there is a need for systems and methods for advertising in an authenticated web-based social network.

### SUMMARY OF THE INVENTION

Exemplary systems and methods are provided for advertising in an authenticated web-based social network. Such methods include providing a screen for creation of a classified advertisement, receiving the classified advertisement from an advertising member, and displaying the classified advertisement on a user network in the authenticated web-based social network with information about a relationship between the advertising member and a member of the authenticated web-based social network viewing the classified advertisement.

Exemplary systems include an advertising engine configured to generate a screen for creation of a classified advertisement, a communications module configured to receive the classified advertisement from an advertising member, a distributed database configured with a user network and relationship information, and a display module configured to display the classified advertisement on the user network with the relationship information.

### BRIEF DESCRIPTION OF THE DRAWINGS

FIG. 1 shows a block diagram of an exemplary architecture for advertising in an authenticated web-based social network;

FIG. 2 is a screenshot of an exemplary landing page for advertising in an authenticated web-based social network;

FIG. 3 is a screenshot of an exemplary expanded classified advertisement;

FIGS. 4-5 show exemplary screenshots of question/answer messaging screens;

FIG. 6 is a screenshot of an exemplary full posting of a classified advertisement;

FIG. 7 shows a screenshot of exemplary relationship information that may be featured in connection with a classified advertisement;

FIG. 8 shows a screenshot of an exemplary flag listing report that may be used to identify a questionable classified advertisement;

FIG. 9 shows an exemplary classified advertisement creation screen that lists some of the categories of classified advertisements that may be featured on a web-based social network;

FIG. 10 shows an exemplary classified advertisement creation screen that lists subcategories of classified advertisements that may be featured on a web-based social network;

FIG. 11 shows a screenshot of an exemplary data entry screen for creating a classified advertisement;

FIG. 12 shows some of the locations on a web-based social network in which classified advertisements may be displayed or featured; and

FIG. 13 shows an exemplary method for advertising in an authenticated web-based social network.

### DETAILED DESCRIPTION OF THE INVENTION

Provided herein are exemplary systems and methods for classified advertising (e.g. advertising) in an authenticated web-based social network. Such systems and methods may verify advertisers as to their identity, reputation, and/or association. Additionally, such systems and methods may facilitate the sharing and display of information about an advertised product or service over a social network. Further, advertised products or services may be targeted to members of the social network who have an affiliation with a particular school, workplace and/or geographic region.

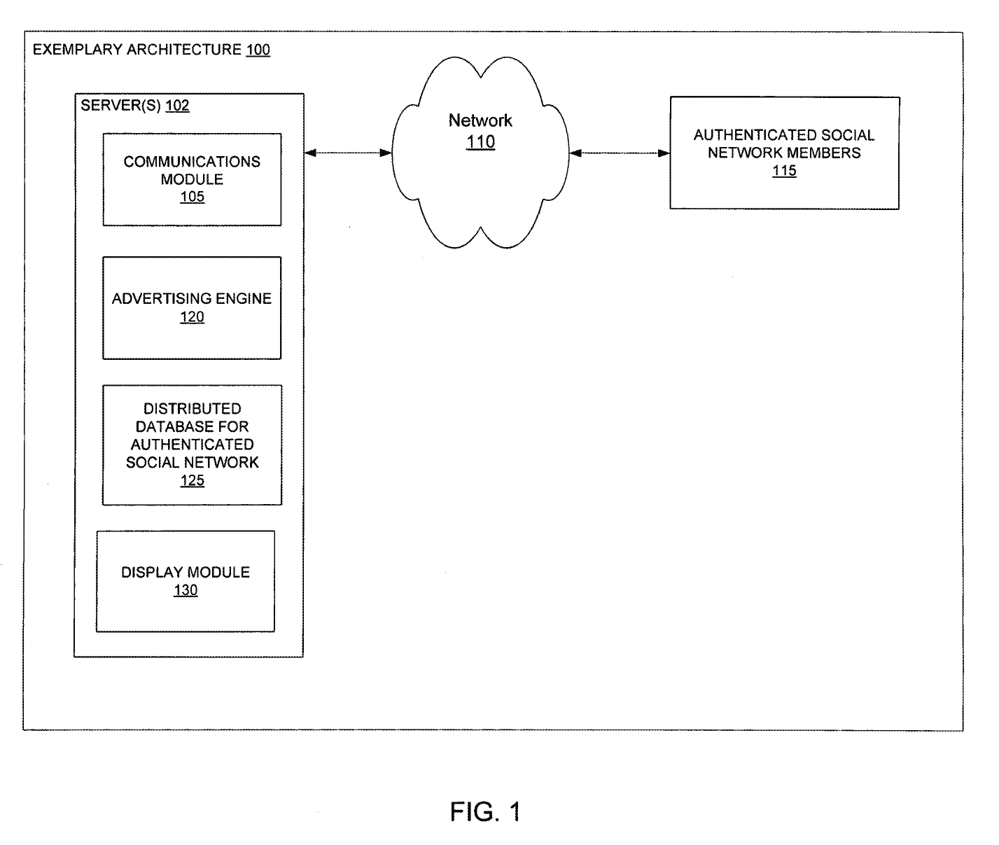

FIG. 1 shows a block diagram of an exemplary architecture for advertising in an authenticated web-based social network. The exemplary architecture 100 includes server(s) 102, a communications module 105, a network 110, authenticated social network members 115, an advertising engine 120, a distributed database for the authenticated social network 125, and a display module 130.

According to one exemplary embodiment, the authenticated social network members 115 are users of computing devices communicating over an electronic network. The network 110 may comprise any electronic network, including the Internet. The server(s) 102 may be associated with the social network. Alternatively, the server(s) 102 may be associated with some other entity, in addition to or in place of the social network.

Certain authentication, verification and/or karma-based technologies may be used to verify or authenticate identity, reputation, and/or association of the users of computing devices as authenticated members of the web-based social network. Such technologies may be found in U.S. patent application Ser. No. 11/701,744 filed on Feb. 2, 2007, titled, “System and Method for Curtailing Objectionable Behavior in a Web-Based Social Network,” U.S. patent application Ser. No. 11/701,595 filed on Feb. 20, 2007, titled “System and Method for Determining a Trust Level in a Social Network,” and U.S. patent application Ser. No. 11/726,962 filed on Mar. 23, 2007, titled “System and Method for Confirming an Association in a Web-Based Social Network,” all of which are incorporated herein by reference.

The advertising engine 120, in various exemplary embodiments, may be configured to generate a screen for creation of a classified advertisement. Such screens may include the various classified advertisement creation screens and data entry screens described and shown herein. The communications module 105, is in communication with the advertising engine 120, and may be configured to receive a classified advertisement created by a member of the authenticated web-based social network. The member creating the classified advertisement is sometimes referred to as an advertising member.

According to one exemplary embodiment, the distributed database for the authenticated social network 125, is in communication with the advertising engine 120 and the communications module 105. The distributed database for the authenticated social network 125 may be configured with one or more user networks and relationship information for the social network. User networks may include members of the web-based social network with an affiliation such as a particular school, employer, and/or geographic region and the like. Relationship information may include friends, colleagues, and/or classmates, etc. in common among the various members of the authenticated web-based social network. Relationship information may also include degrees of separation among various members of the authenticated web-based social network.

The display module 130, according to various embodiments, is in communication with the advertising engine 120, the communications module 105, and the distributed database for the authenticated social network 125, and may be configured to display a classified advertisement on a user network with relationship information.

The embodiments discussed herein are illustrative. As these embodiments are described with reference to illustrations, various modifications or adaptations of the methods and/or specific structures described may become apparent to those skilled in the art. The above-described components and functions can be comprised of instructions that are stored on a computer-readable storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage medium.

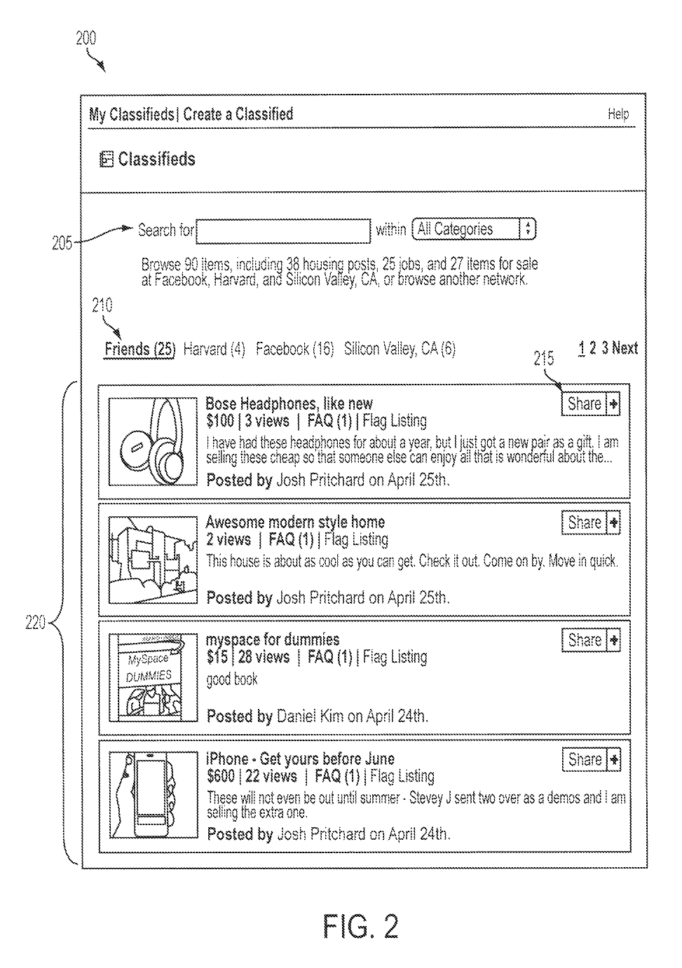

FIG. 2 is a screenshot of an exemplary landing page for advertising in an authenticated web-based social network. Screenshot 200 includes a search selection 205, a network selection 210, a share selection 215, and advertisements 220.

According to various exemplary embodiments, the search selection 205 allows a member of a web-based social network to enter a name of a product or service they wish to find. The member may also select a category of item that corresponds to the entry. Alternatively, the member may perform a search based on category without entering the name of a product or service.

The network selection 210 may include networks for which a member of a web-based social network has an authenticated affiliation, such as a school, a geographic region, and/or a particular workplace. By activating a particular network selection, a member may view items or services being offered by other members of that particular network. As a result, within an authenticated social network, members may interact with a high level of confidence about the nature of the product or service, as well as the party offering that product or service.

Further, the network selection 210 may allow a member of a web-based social network to query and/or view the classified advertisements on other user networks comprising the web-based social network. For example, a member of the University of California at Los Angeles (“UCLA”) user network may be interested in renting an apartment in New York City and may query the listings of the New York City geographic user network for available apartments.

The share selection 215, according to one exemplary embodiment, allows a member to share a particular classified advertisement with one or more other members of the web-based social network. For example, a member may use the share selection 215 to display a particular classified advertisement on their profile or may send the classified advertisement to another member or group of members. Classified advertisements may also be shared on a news feed displayed to other members of the web-based social network. Screenshot 200 also shows exemplary classified advertisements 220. Classified advertisements may be for products and/or services. Classified advertisements may also include postings, listings, announcements, polls, pools, surveys, and/or news items of a commercial or non-commercial nature.

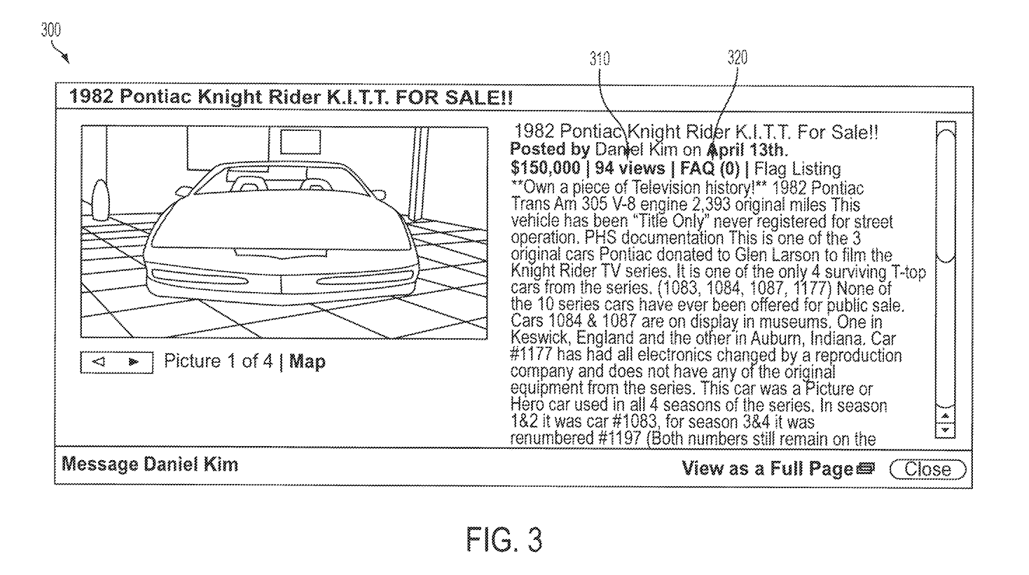

FIG. 3 is a screenshot of an exemplary expanded classified advertisement. Screenshot 300 includes page view information 310, and frequently asked questions (“FAQ”) 320. According to one exemplary system and method, when a member clicks on, drags or moves a cursor or other similar means over a particular classified advertisement, the classified advertisement may be displayed in an expanded and more detailed format, such as in the format shown in screenshot 300. Further, such an expanded and detailed format may be displayed as an overlay with respect to the landing page or another page, or it may be displayed as an inset or by itself within or outside of the web-based social network.

Page view information 310 displays how many times a particular classified advertisement has been viewed. This information may be displayed selectively such as to the advertising member and/or to an administrator of the web-based social network. Alternatively, this information may be displayed to anyone viewing the classified advertisement. FAQ 320 may display whether there are questions/answers with respect to the classified advertisement, and assuming the existence of questions/answers, FAQ 320 may be clicked, highlighted and/or otherwise activated by anyone viewing the classified advertisement in order to view the questions and/or answers about the advertised subject matter.

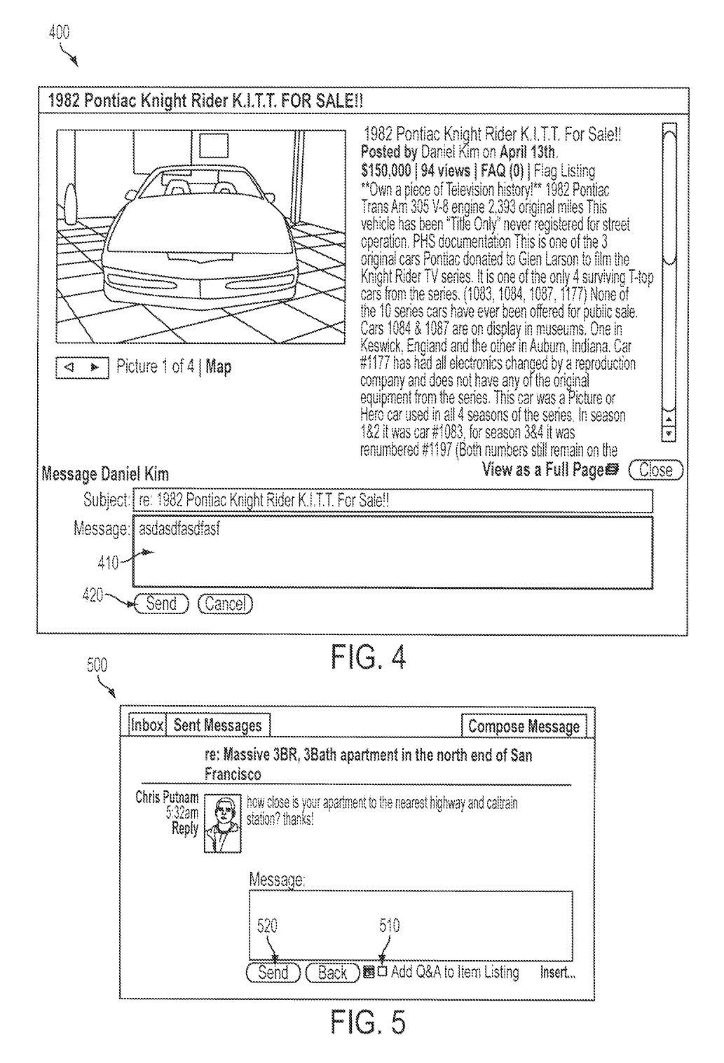

FIGS. 4-5 show exemplary screenshots of question/answer messaging screens. Screenshot 400 shows message entry space 410 and a send message selection 420. Screenshot 500 shows add question/answer to classified advertisement selection 510 and a send answer selection 520.

In one embodiment, a member viewing a classified advertisement such as the classified advertisement shown in screenshot 300 (FIG. 3), may wish to send a message, make an inquiry and/or question an advertising member about their classified advertisement. With or without activating a message selection mechanism or other similar feature, the member viewing the classified advertisement may compose a question for the advertising member. Accordingly, the viewing member may use message entry space 410 to enter a question about the classified advertisement. The viewing member may use the send message selection 420 to send the question to the advertising member.

In a further embodiment as illustrated in screenshot 500, a question is displayed for response by an advertising member. After the advertising member enters a response to the question, the advertising member may use the send answer selection 520 to send the response. The advertising member may use the add question/answer to classified advertisement selection 510 to display a question and/or an answer about a classified advertisement to other members of the web-based social network viewing the classified advertisement. Additionally, each displayed question and/or answer may result in an indicator such as FAQ 320 (FIG. 3) displaying the number of questions and/or answers that have been raised by other members of the social network about a particular classified advertisement. Alternatively, the advertising member may elect to send a private response to a question asked by the viewing member. Private messages and/or private responses may be sent over a messaging system that is part of the web-based social network or over a messaging system that is external to the web-based social network. Those messages and/or responses sent over the messaging system that is part of the web-based social network are less likely to be erroneously filtered out by spam filters typically associated with messaging systems external to the web-based social network.

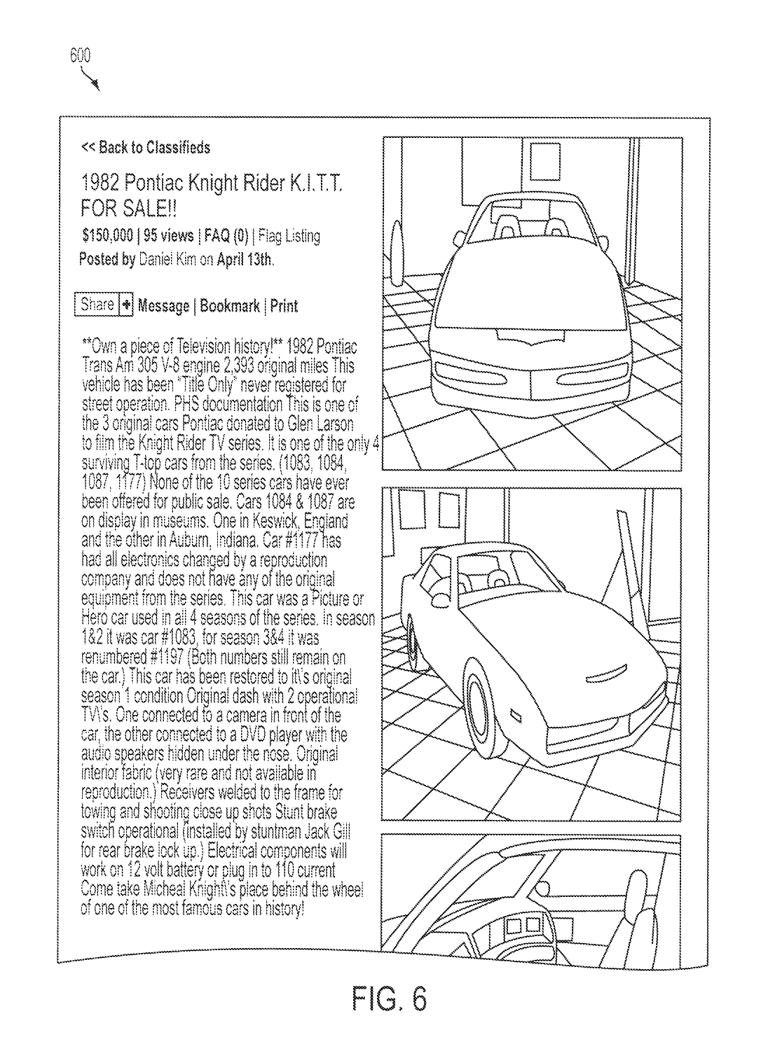

FIG. 6 is a screenshot of an exemplary full posting of a classified advertisement. According to one embodiment, the full posting may include additional information, such as multiple photos or images, about a particular product and/or service featured in a dassified advertisement. The full posting may also include messages, inquiries, questions, answers, responses, and/or comments of the advertising member and/or members viewing the classified advertisement. The full posting may include a selection or command that a viewing member may use to share the classified advertisement with others, to message the advertising member, to bookmark the classified advertisement, and/or to print the classified advertisement.

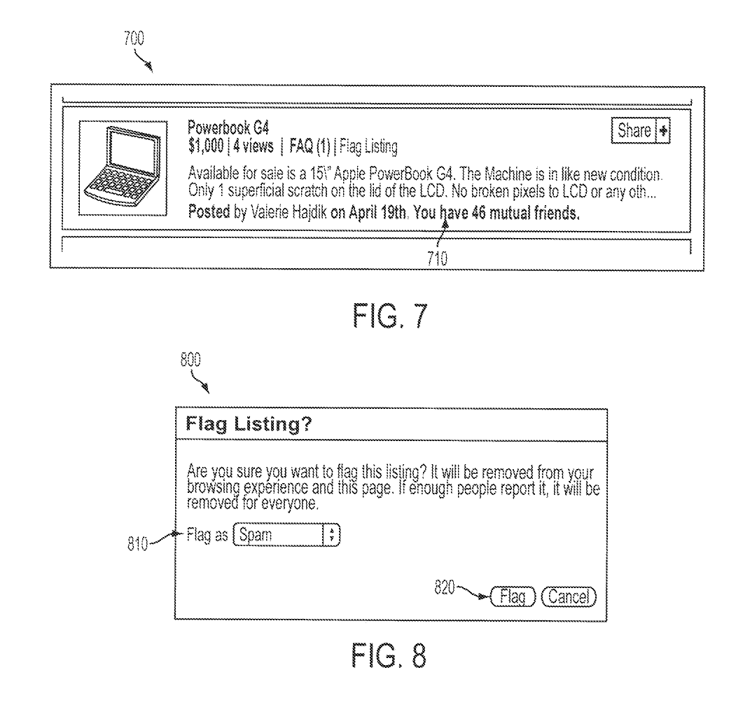

FIG. 7 shows a screenshot of exemplary relationship information that may be featured in connection with a classified advertisement. Screenshot 700 includes relationship information 710. In one system and method, a classified advertisement may include the relationship information 710 about an advertising member, including how many friends or members of the web-based social network the particular advertising member has in common with the member viewing the classified advertisement. For example, as shown in screenshot 700, the member of the web-based social network viewing the classified advertisement for the laptop computer may learn through the relationship information 710 that the advertising member has forty-six (46) friends in common with the viewing member. Other relationship information such as the identities of shared friends, degrees of separation, geographic distance of separation, etc, may be used in addition to or in place of the relationship information 710 and remain within the scope of the various embodiments contemplated herein.

FIG. 8 shows a screenshot of an exemplary flag listing report that may be used to identify a questionable classified advertisement Screenshot 800 includes flag listing category selection 810, and send flag listing selection 820. According to various embodiments, the flag listing report is a mechanism by which a member of a web-based social network may have a classified advertisement removed from the member's viewing experience. For example, a member of a web-based social network may use the exemplary flag listing report shown in screenshot 800 to report a questionable classified advertisement by employing the flag listing category selection 810 to indicate a category that best describes the problem with a particular questionable classified advertisement. Exemplary categories may include “spam,” “fraudulent,” “illegal,” “scam,” and so forth. The member may use the send flag listing selection 820 to send the report to the web-based social network and/or an administrator of the social network. If a certain number of members report a particular classified advertisement, it may be removed from their own viewing pages on the social network, and/or the social network may remove the classified advertisement from some or all of the user networks that form the web-based social network. The removal of a classified advertisement from some or all of the user networks may be accomplished in a number of ways, including manually by a system administrator, or automatically by a reporting algorithm. For example, the number of times a particular classified advertisement and/or an advertising member is reported by members of the social network may be manually and/or automatically tracked. If a certain number of reports are received for a particular classified advertisement and/or a particular advertising member, the classified advertisement may be removed from some or all of the user networks. Alternatively, links associated with the particular classified advertisement may be disabled, and/or the advertising member's access, to the social network may be terminated or curtailed.

Additionally, certain authentication, verification, and/or karma-based technologies may be used with some or all of the herein described systems and methods of advertising. Such technologies may be employed to reduce or eliminate spam within a social network. Further, non-members of a web-based social network may be authenticated and/or verified at least in part by being required to pay for a posting or a listing of a classified advertisement. Payment may include the use of a credit card or other means that may be tracked. Further, some or all of the advertisers may be limited in the number of classified advertisements they may post at a particular time. Internet users or viewing members that improperly and/or inaccurately flag or report advertisers or classified advertisements may have their credit rating, karma, authentication, and/or verification scores reduced, which may impact their ability to post and/or view future classified advertisements. It will readily be appreciated that many variations of authentication, verification and/or karma-based technologies may be used and still fall within the scope of the various systems and methods contemplated herein.

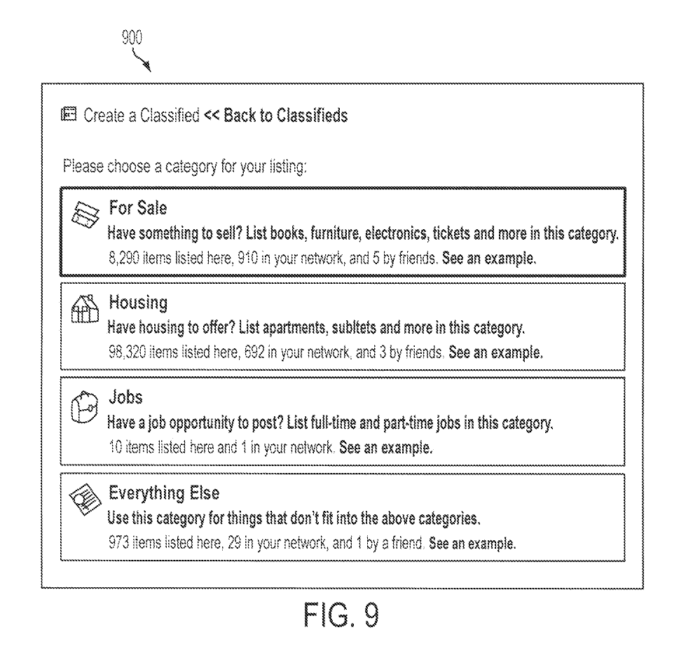

FIG. 9 shows an exemplary classified advertisement creation screen that lists some of the categories of classified advertisements that may be featured on a web-based social network. The exemplary advertisement creation screenshot 900 lists categories such as “For Sale,” “Housing,” “Jobs,” and “Everything Else.” Within each category is information such as a description of the category, number of items listed in the category, number of items listed in the category for a particular network, and/or how many items in the category are listed by friends of the viewing member. It will readily be appreciated that many variations, additions and/or deletions of information may be featured in such an advertisement creation screen and still fall within the scope of the various systems and methods contemplated herein.

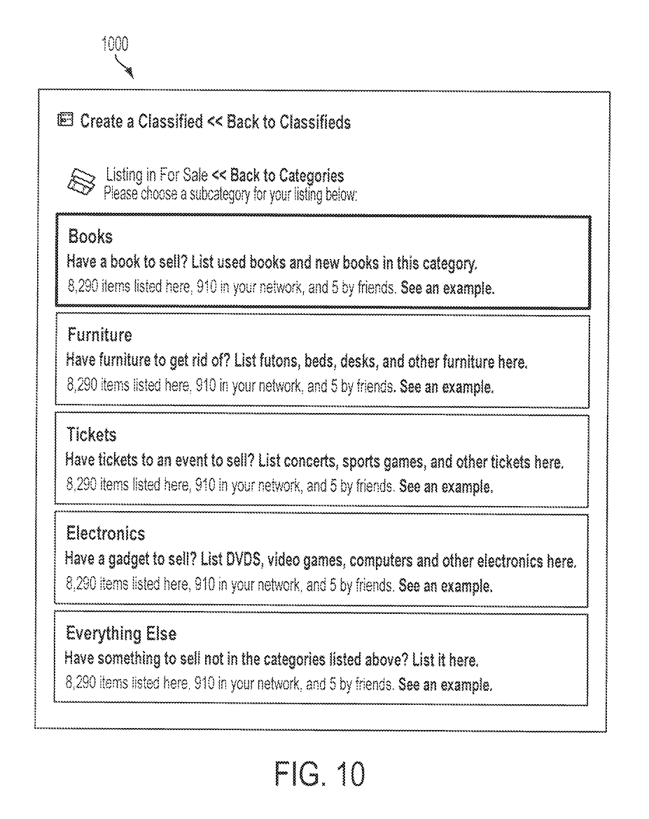

FIG. 10 shows an exemplary classified advertisement creation screen that lists subcategories of classified advertisements that may be featured on a web-based social network. For example, the advertising member that selected the “For Sale” category on the exemplary advertisement creation screen 900 (FIG. 9) may select from subcategories such as “Books,” “Furniture,” “Tickets,” “Electronics,” and/or “Everything Else” in which to display a classified advertisement. Within each subcategory may be a description of the subcategory, number of items listed in the subcategory, number of items listed in the subcategory for a particular network, and/or how many items in the subcategory are listed by friends. It will readily be appreciated that many variations, additions and/or deletions of information may be featured in such an advertisement creation screen and still fall within the scope of the various systems and methods contemplated herein.

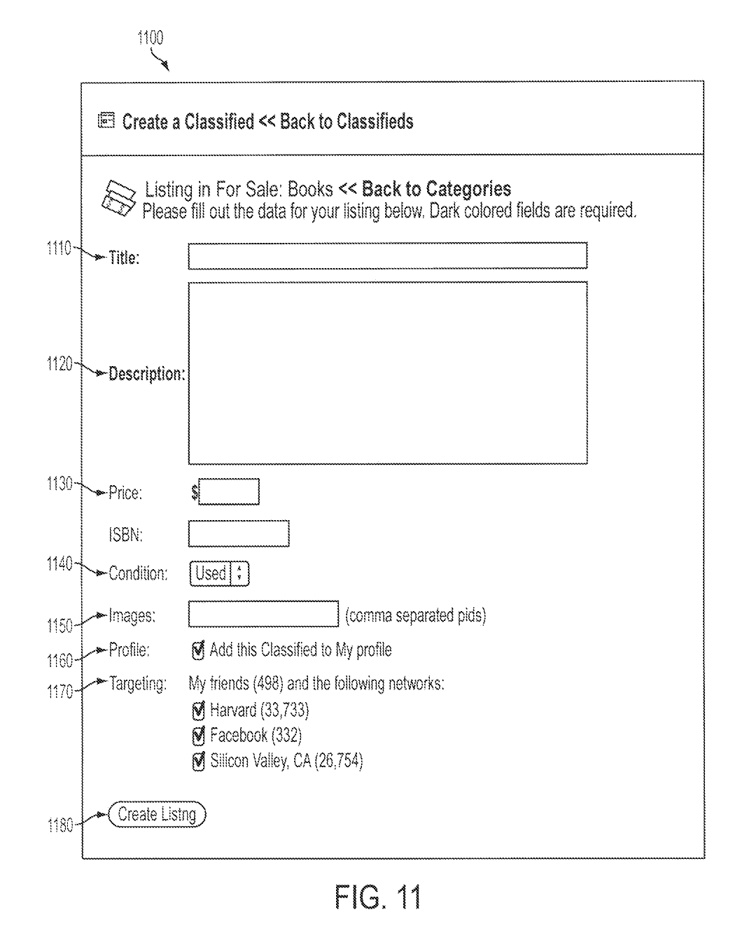

FIG. 11 shows a screenshot of an exemplary data entry screen for creating a classified advertisement. The exemplary data entry screen 1100 includes title entry 1110, description entry 1120, price entry 1130, condition entry 1140, image upload selection 1150, profile display option 1160, targeting selection 1170, and create listing command 1180. According to one exemplary system and method, after an advertising member selects one or more categories and/or subcategories of a product and/or service they wish to advertise (as shown and described in connection with FIGS. 9-10 herein), the advertising member may be directed to the exemplary data entry screen 1100 to enter information about the particular product or service. For example, an advertising member may use the exemplary data entry screen 1100 to sell a book by entering a book title in title entry 1110, information about the book author and publication date in description entry 1120, a selling price in price entry 1130, the book's condition in condition entry 1140, and/or upload a picture of the book's cover using image upload selection 1150. Additionally, the advertising member may elect whether to display the classified advertisement on their web-based social network profile page by selecting the profile display option 1160, and the advertising member may select a user network such as “Harvard,” “Facebook,” and/or “Silicon Valley, Calif.” in which to feature the classified advertisement. For example, with respect to the screenshot 1100, the advertising member has targeted the user networks of Harvard University (school), Facebook (workplace), and Silicon Valley, Calif. (geographic region) to receive the particular classified advertisement for the advertised book. In a further system and method, the advertising member may target a classified advertisement to specific members of a web-based social network based on demographic parameters. For example, a classified advertisement may be targeted to 23 year-old women associated with the Boston geographic region. If the advertising member is satisfied with their entries on the exemplary data entry screen 1100, they may select the create listing command 1180 to send the classified advertisement to the selected user networks on the web-based social network. The classified advertisement may or may not be manually and/or automatically screened by the social network or an administrator for the social network. In yet a further system and method, an advertising member may create a classified advertisement and send it to the web-based social network via a mobile phone or other mobile computing device.

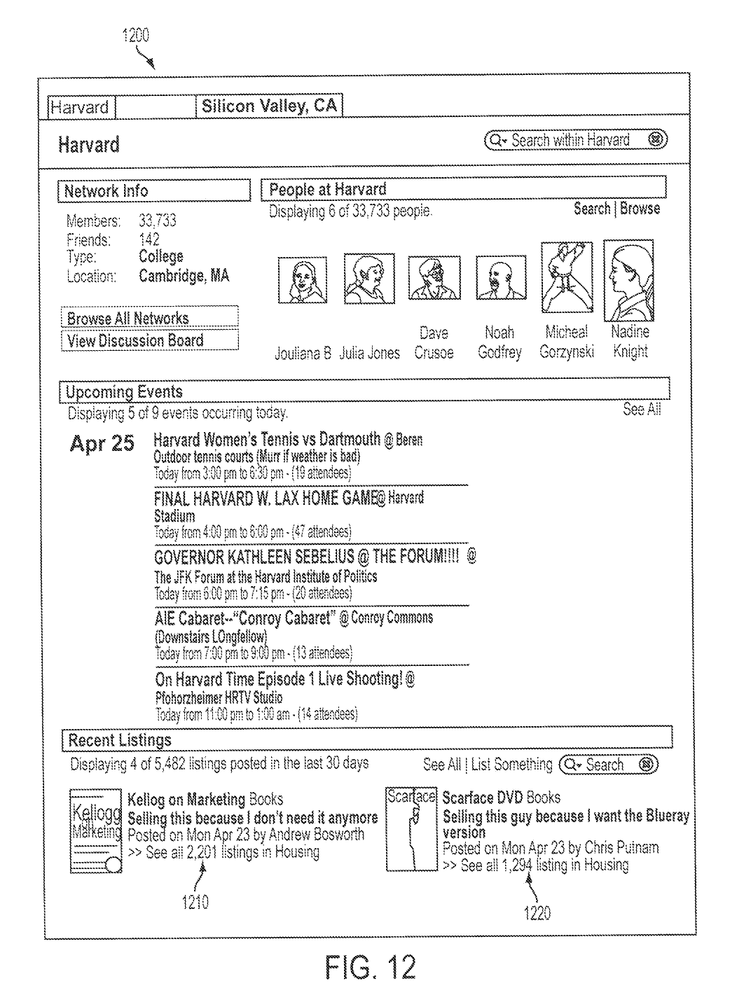

FIG. 12 shows some of the locations on a web-based social network in which classified advertisements may he displayed or featured. Shown in screenshot 1200 is an exemplary network portal where classified advertisements 1210 and 1220 may appear on a rotating basis to members viewing the illustrated screen. In addition to the exemplary locations illustrated in screenshot 1200, the classified advertisements such as classified advertisements 1210 and 1220 may appear in a similar fashion and/or in a modified fashion in such locations as a personal profile page for a particular member of a web-based social network and/or on a news feed for the social network.

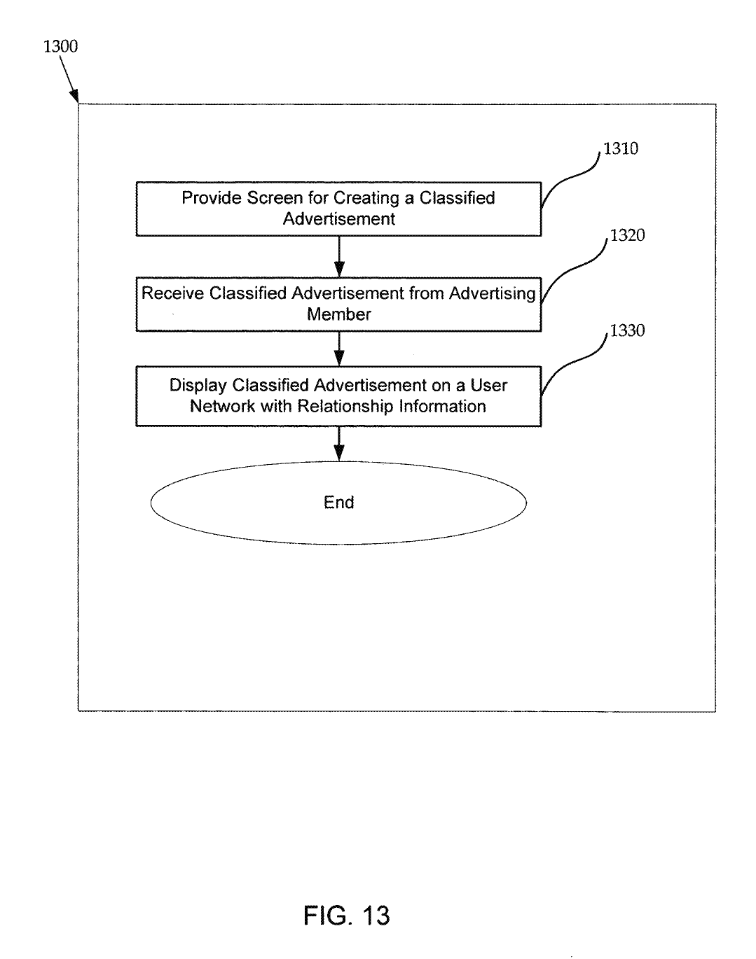

FIG. 13 shows an exemplary method for advertising in an authenticated web-based social network. The exemplary method 1300 comprises the following steps:

At step 1310, one or more screens for the creation of a classified advertisement are provided. According to one system and method, after an advertising member is provided with a screen having a choice of one or more categories and/or subcategories of a product and/or service they wish to advertise as shown and described in connection with FIGS. 9-10 herein, the advertising member may be provided with a second screen such as the exemplary data entry screen 1100 (FIG. 11) to enter information about the particular product or service.

At step 1320, a classified advertisement from an advertising member is received. For example, after the advertising member has entered data in the exemplary data entry screen 1100 as described in connection with step 1310, a corresponding classified advertisement may be received by the web-based social network.

At step 1330, the classified advertisement is displayed on a user network in the authenticated web-based social network with information about a relationship between the advertising member and a member of the social network who is viewing the advertisement.

While various systems and methods have been described above, it should be understood that they have been presented by way of example only, and not limitation. Thus, the breadth and scope of a preferred embodiment should not be limited by any of the above-described exemplary systems and methods.

1-5. (canceled)

6. A method comprising:
selecting a group of viewing users from a plurality of users of a social networking system to be eligible to view an advertisement, the advertisement provided by an advertiser;
sending the advertisement from the social networking system for display to one or more of the selected viewing users;
receiving a report from one or more of the selected viewing users that flags the advertisement as a questionable advertisement;
determining whether a number of other reports have been received for the advertiser indicating that the advertiser has provided a questionable advertisement for display on the social networking system; and
based on the number of reports received exceeding a certain number, disabling or removing the advertisement from display for the selected viewing users to whom the advertisement was sent for display.

7. The method of claim 6, wherein the advertisement is removed automatically by a reporting algorithm.

8. The method of claim 6, wherein the report is received through a flag listing report system that allows the selected viewing user to have an advertisement removed from a viewing experience of the selected viewing user.

9. The method of claim 6, wherein the report received is a flag listing category selection that indicates a category that describes a problem with the questionable advertisement.

10. The method of claim 9, wherein the flag listing category is selected from a group consisting of: spam, fraudulent, illegal, and scam.

11. The method of claim 6, further comprising:
determining that the report received was an improper or inaccurate report; and
reducing a credit rating, karma, authentication, or verification score of the selected viewing user who provided the improper or inaccurate report.

12. The method of claim 11, wherein the reduced score of the selected viewing user limits an ability of the selected viewing user to post advertisements on the social networking system.

13. The method of claim 6, wherein the disabling or removal of the advertisement negatively affects a reputation of the advertiser for advertising within the social networking system.

14. The method of claim 13, further comprising preventing the advertiser from posting advertisements in the social networking system based on the negatively-affected reputation of the advertiser.

15. The method of claim 6, wherein the disabling or removal of the advertisement results in termination of access of the advertiser to the social networking system.

16. The method of claim 6, further comprising removing the advertisement from display for the selected viewing users and for other users of the social networking system.

17. The method of claim 6, wherein disabling the advertisement comprises disabling one or more links within the advertisement.

18. The method of claim 6, further comprising
verifying a reputation of another advertiser within the social networking system prior to sending an advertisement of the other advertiser to selected viewing users; and
preventing the other advertiser from providing the advertisement within the social networking system based the other advertiser having a negative reputation.

19. The method of claim 18, wherein the other advertiser is not a member of the social networking system and wherein verifying the reputation of the other advertiser occurs by requiring the other advertiser to pay for posting the advertisement.

20. A method comprising:
selecting a group of viewing users from a plurality of users of a social networking system to be eligible to view an advertisement, the advertisement provided by an advertiser;
sending the advertisement from the social networking system for display to one or more of the selected viewing users, the advertisement comprising a field for receiving questions or answers;
receiving, at the social networking system, a question provided by one of viewing users about the advertisement;
receiving, at the social networking system, an answer to the question from the advertiser; and
providing at least one of the question and the answer for display to other users of the social networking system.

21. The method of claim 20, wherein providing the question and answer for display comprises providing an interface through which viewing users can access questions and answers associated with an advertisement.

22. The method of claim 20, further comprising receiving an answer to the question from another viewing user.

23. The method of claim 20, further comprising receiving a private response to the question and sending the private response only to the viewing user who provided the question.

24. The method of claim 20, wherein each question or answer provided for display results in an indicator displaying a number of questions or a number of answers that have been raised by other members of the social networking system the advertisement
